(19) United States
(12) Patent Application Publication
(10) Pub. No.: US 2019/0125110 A1
(43) Pub. Date: May 2, 2019

(54) MULTI-ANGLE FEEDING CUP

(71) Applicant: Gabriel Hendrik ROUX, Kearneys Spring (AU)

(72) Inventor: Gabriel Hendrik ROUX, Kearneys Spring (AU)

(21) Appl. No.: 16/089,855

(22) PCT Filed: Mar. 31, 2017
(86) PCT No.: PCT/AU2017/050283

§ 371 Date: Sep. 28, 2018

(30) Foreign Application Priority Data
Mar. 31, 2016 (AU) 2016202017

(51) Int. Cl. A47G 19/22; A61J 9/06; A61J 11/00; A61J 11/04

(52) U.S. Cl. CPC A47G 19/2272; A61J 11/04; A61J 11/0015; A61J 9/06

(57) ABSTRACT

The invention relates to a multi-angle cup for feeding liquid food to a patient, the cup including, a body including a wall and an exit channel extending at an angle from the wall. A mouth part is also included, extending from the angled exit channel and an inclined angle to enable the patient to be fed liquid food in a controlled manner to the posterior aspect of the tongue through use of a bulb with a hole and valve arrangement. The multi-angle feeding cup enables feeding at substantially any angle of tilt of the cup, and the flow of the liquid food is controlled by the mouth piece. The invention also relates to methods of use and a method of testing.

### FIELD OF THE INVENTION

The present invention relates to a multi-angle feeding cup, and in particular to a multi-angle feeding cup for feeding thickened liquid food to a patient.

### BACKGROUND OF THE INVENTION

People are living longer and as such the period of our life spent as an elderly person is extended. Many elderly people develop dementia and may lose the ability to feed themselves or may only be able to feed themselves safely with assistance from their carer, for example patients with dysphagia. At this stage of life it is desirable to feed thickened liquid food to a patient. Liquid foods are produced in powder form generally, which can be made up prior to use with a liquid such as water or milk. The nutritional content of the measured dose of liquid food is known so that this is measurable and recordable.

The difficulty with thickened liquid food preparations are that these are much thicker than water, and as such have different viscosities, making feeding from a standard cup inconvenient or impossible. There are generally three levels of fluid thickness, which the industry is attempting to standardise. These thicknesses of liquid food may be described as: “Level 150”, mildly thick where fluid flows but will coat a spoon and requiring at least a 0.5 mm hole for fluid flow; “Level 400”, moderately thick, would drop off a spoon in dollops, rather than running, requiring a 1.0 mm hole for fluid flow; and “Level 900”, extremely thick, where there is no flow and the liquid food would remain on a tilted spoon, requiring a 2.0 mm hole for fluid flow. As mentioned, there are efforts to standardise these thicknesses to assist in the care of dementia and patients with dysphagia.

The size of hole in alternative feeding cups for these fluid thicknesses is insufficient to enable flow to properly feed an adult. Optimal flow dynamics of the thickened liquid food is a serious consideration in order that flow occurs at a suitable rate to feed the adult, and that is readily managed and achieved by the carer, with minimal risk of aspiration and choking.

Level 400 and Level 900 thickness of liquid are of particular issue as they cannot be fed through a so called “sippy cup” as the thickened food is too thick to flow. Similarly, use of a straw is not possible as the material is too thick for the elderly person to be able to suck up through the straw. Therefore, at present Level 400 and Level 900 fluids are typically spoon fed or direct fed from an open cup, which has a high risk of aspiration and choking. Elderly patients are mostly not in command of these functions and so can readily choke, and the carer must take action to try to minimise the choking risk. Where the patient is neurologically compromised the person will have poor grip, coordination and dexterity which prevent safe feeding by themselves. Dysphagia is common and so feeding must be carefully supervised and controlled for safe feeding to occur and to feed sufficient nutrient to the patient, to maintain their best possible quality of life.

Where a patient is fed from a feeding cup, this typically excludes a patient who is sitting upright as the angle of tilt of the cup will be insufficient to enable feeding of the thickened liquid without hazardous hyperextension of the neck in older people. Where a patient is sitting up, the thicker levels of thickened food usually are fed with a spoon. Placing a varying size food bolus indiscriminately with a spoon in the mouth of a patient with impaired swallowing reflexes, causes repetitive incidents of aspiration. A situation made worse by carer unawareness of the accumulation of un-swallowed food in the retro-pharynx.

To try to address some of these issues the inventor developed the RoseCup (TRADE MARK) an invention subject of PCT/AU2011/001621 with a long wide spout extending from a wall of the cup. The long wide spout enabled thicker liquids to be dispensed at the back of the mouth to utilise the autonomic suck and swallow reflexes. The previous form of the cup was a significant advance in safety and feeding of dementia patients. The inventor has continued to develop and refine the invention over the last 5 years, and has now made a further leap forward in the technology. The inventor has developed a significant elevation in safety standards by use of the invention, which is mainly achieved in 3 ways:
1. Flow Control, for all 3 liquid food thicknesses the hole sizes of the inventive mouth piece and proprietary formulas were both tweaked and matched to produce effectively no flow through the hole in the mouth piece when the cup is tipped downwards. This significant safety measure ensures that unless the patient first sucks he or she will not get any food deposited in his mouth. The correct functioning of the flow control of the invention is checked by the carer every time, before feeding the patient;
2. Tidal Volume Control, the bulb of the mouth piece of the invention was set to hold about 3 millilitres of thickened fluid during any one cycle. With compression of the bulb the base of the bulb is blocked by the tip of the tongue and only the content of the bulb is delivered through the prolapsing cusps of the valve onto the tongue. The valve closes after the suck-cycle (restores to “hole-only” state) and no further liquid will escape from the device due to the flow control. The control of the delivery and arrest of the tidal volume ensures that the volume per suck-cycle is no more than 3 millilitres. The effective interruption of the suck-cycle safeguards the airways. The correct function is checked by the carer every time before feeding the patient, for safety; and
3. Initiating optimal reflex cascades for safe swallowing. The inventor suspects that irrespective of stage or etiology, if the swallowing mechanism in dysphagia is initiated by the suck reflex, the swallow mechanism is much more likely to be effective and complete than with traditional feeding methods. He also suspects that the reflex link between suck and swallow is so strong, that suck-initiated swallowing, likely constitutes the strongest reassurance against pharyngeal accumulations with its associated aspiration risks. The invention represents a significant inventive move forward in safe feeding of patients with dysphagia.

Use of an angled wide exit channel, as in the subject invention, with a specifically designed mouth piece enables controlled, safe and efficient feeding of an elderly patient, including when the cup is fully inverted. The inventor has made a significant advance over the art, with multiple inventive features, which is likely to be very well received by the industry and readily adopted internationally, once the invention becomes known.

The following describes a non-limiting example of the invention being used to feed a thickened liquid food to an elderly patient with dysphagia, as a particular useful application of the invention. However, clearly the nature of the food may be varied and it is not intended that the invention be limited to the described thickened liquid foods. Further, the invention may be useful for many patients with a range of medical or health conditions, including younger neurologically compromised adults. It is not intended that the scope of use of the invention be limited in any way, other than as specified in the claims.

For clarity, any prior art referred to herein, does not constitute an admission that the prior art forms part of the common general knowledge, in Australia or elsewhere.

It is an object of the present invention to provide a multi-angle cup that at least ameliorates one or more of the aforementioned problems of the prior art. It is a further object of the invention to provide methods of use of a multi-angle cup.

### DISCLOSURE OF THE INVENTION

Accordingly, the present invention provides a multi-angle feeding cup for feeding liquid food to a patient, the cup including:
a cup body for containing the liquid food, and including a wall;
an exit channel extending at an angle from the wall; and
a mouth part extending from the angled exit channel at an inclined angle, and the mouth part including a bulb with a hole and a valve arrangement, the hole being of a suitable size to enable feeding with a controlled flow rate, depending on the thickness of the liquid food to be fed, and the mouth part and bulb with valve arrangement and hole being adapted to enable the patient to be fed liquid food with a controlled flow rate and tidal volume, to the posterior aspect of the tongue,
   wherein the multi-angle feeding cup enables feeding at substantially any angle of tilt of the cup.

Preferably, the multi-angles of feeding are any angle of feeding. The angles may be to allow feeding when the mouth part is substantially horizontal, vertical or any angle in between. The angles may be at any angle suitable to feed an adult patient. In an inferior form of the invention flow in one or more particular direction or use in one or more tilt direction may be prevented.

The multi-angle feeding cup may be used to feed any suitable liquid, of a thickness to be controlled by the mouth piece. Preferably, the multi-angle feeding cup is used to feed thickened liquid food. The thickened liquid food is preferably of a form of predicable nutritional value once made up, to enable monitoring of feeding of the patient. Any suitable fluid food may be used with the inventive cup. However, it is beneficial to use the multi-angle cup with prescribed thicknesses of liquid food, suitable for the particular patient. The particular food and thickness may be determined by a health professional as most suitable. It is advantageous that use of the multi-angle cup and standardised thicknesses of liquid enables a health professional to have certainty as to the thickness of food fed, which can be adjusted reliably therefore, as the patient's ability to feed changes.

The thickened liquid food may be products sold under the brand NutriTaste (Trade Mark). The thickened liquid food may be made up to standardised thicknesses. The standardised thicknesses may be determined by the industry. Preferably, the standardised thickness is: “Level 150”, mildly thick where fluid flows but will coat a spoon; “Level 400”, moderately thick, would drop off a spoon in dollops, rather than running; and “Level 900”, extremely thick, where there is no flow and the liquid food would remain on a tilted spoon. The standardised thicknesses may be “Level 150”, mildly thick where fluid flows but will coat a spoon and requiring at least a 0.5 mm hole for fluid flow; “Level 400”, moderately thick, would drop off a spoon in dollops, rather than running, requiring a 1.0 mm hole for fluid flow; and “Level 900”, extremely thick, where there is no flow and the liquid food would remain on a tilted spoon, requiring a 2.0 mm hole for fluid flow. There may be coordinated colour coding of the level of thickness to be fed and the mouth piece of the cup, to facilitate use. Most preferably, consistent colour coding is used for the mouth piece and food packaging for a particular level of standardised fluid thickness. These colours may be determined by the industry as standardised colours denoting thickness.

Preferably, the patient is a dysphagia patient. The patient may be a dementia patient. The patient may be an elderly person. The patient may be any adult with difficulty feeding. The patient may be a neurologically compromised person, including a young adult.

Preferably, the cup is manufactured in one or more parts and supplied to the carer for assembly and use. The cup may be provided in kit form with a ranges of suitable mouth pieces. The range of suitable mouth pieces may be one each suitable for Level 150, Level 400 and Level 900. A sample kit may also be provided with samples of suitable foods to make up to Level 150, Level 400 and Level 900 to correspond to the mouth pieces. In this way a carer has access to a full range of options, in one handy pack.

The cup body and exit channel may be made of a rigid material. Preferably, a suitable plastics material is used. Preferably the cup body and exit channel are made substantially of an Acrylonitrile butadiene styrene (“ABS”) plastics material. Parts of the cup may be made of thermoplastic elastomers (“TPE”). Parts of the cup may be made of silicone. The cup and its parts may be made of any suitable materials and combination of materials.

Preferably, a rigid cup body is included. The cup body may be any suitable size and shape to contain thickened liquid food. Preferably, the body of the cup has a base and the wall extends up from the base to form the cup body for containing liquid. Preferably, the wall extends out from the floor at an angle. The cup may be any suitable shape. In other forms of the invention there may be more than one wall, such as in a square based cup. Preferably, the base of the cup is substantially stable when placed on a flat surface. Preferably, the base of the cup may be substantially flat. Preferably, the base of the cup is substantially circular and the wall extends up and out from the substantially circular base.

Preferably, the cup body is made of a rigid plastics material. The cup body is preferably made of a strong usable plastics material that is readily cleaned.

Preferably, the copy body is configured to contain a suitable volume of thickened liquid food to feed an adult patient. Preferably, a lid is included to the cup body to enclose the top thereof. The lid may take any suitable form. Preferably, the lid seals tight to prevent loss of fluid during use. The lid may be substantially circular and screw onto a corresponding circular top of the cup. Other forms of lid and seal may be included.

Preferably, more than one handle is included. Preferably, more than two handles are included. Preferably, there are three handles extending out from the cup. Preferably, the handles extend from the wall of the cup body. In other forms of the invention the handles may be attached to the base and or lid instead. Preferably, the handles are attached to two points of the multi-angle cup for improved hold. Preferably, three handles are included, one on either side of the exit channel and one to the rear.

Preferably, the handles are spaced at 90 degrees to either side of the exit channel with the rear handle spaced 90 degrees from the other two. Most preferably, the three handles enables ready use of the multi-angle cup in any direction with a choice of multiple holds. Preferably, the patient and or carer can hold the multi-angle cup through use of one or more of the handles. Preferably, both the patient and the carer can hold the cup at the same time through use of the handles. A patient may hold the cup while a carer maintains contain with a handle in case that grip is lost. There are a multitude of angles, and options of hold with the subject inventive multi-angle cup. Preferably, grip is included on the handle. The grip may be a silicone grip.

Reinforcement or shaping may be included in any parts of the cup body to assist manufacture or for the multi-angle cup to maintain integrity through extended use.

The wall is preferably a smooth wall extending from the base towards a top of the cup. The wall may be any suitable thickness. Preferably, the wall is rigid and of a suitable thickness to resist deformation under pressure.

Preferably, the exit channel is made of a rigid plastics material. Preferably, the exit channel is made of an Acrylonitrile butadiene styrene (“ABS”) plastics material Other suitable plastics may be used instead. Preferably, the exit channel extends from the wall of the cup towards a base. Preferably, the exit channel extends from the wall of the cup at the base. Preferably, the exit channel extends from the base of the cup to be substantially level with a top of the cup. Preferably, the exit channel is a wide channel with a large opening with the body of the cup. Preferably, the wide opening of the exit channel with the body of the cup is at least 20 millimetres wide. Preferably, the wide opening of the exit channel with the body of the cup is at least 22 millimetres wide. Most preferably, the opening of the body of the cup with the exit channel has dimensions of substantially 22 millimetres by 55 millimetres.

Preferably, the exit of the exit channel to the mouth piece is at least 20 millimetres wide. Preferably, the exit of the exit channel to the mouth piece is at least 22 millimetres wide. Other suitable wide sizes of opening and exit may be used. The size is important to enable the thicker levels of thickened level food to be fed.

Preferably, the exit channel extends at an angle in the range of substantially 25 to 45 degrees to the vertical. Most preferably, the exit channel extends at an angle of substantially 30 degrees to the vertical. Use of 30 degrees has been found to be most advantageous. Preferably, the exit channel extends from the base of the cup at substantially 30 degrees to the vertical and has an opening and exit of at least 20 millimetres width.

Preferably, mouth parts may be interchangeably attached to the exit channel. The attachment of the mouth parts to the exit channel may be through any suitable means. Preferably, the mouth parts can be quickly and easily installed or released as required. Preferably, the mouth part includes a cuff and it is the cuff that attaches to the exit channel. Preferably, the mouth parts will only be fitted to the exit channel such that the mouth parts present in the correct orientation for use. A slot-and-groove arrangement may be used between the mouth part and exit channel ensures that the mouth part is correctly orientated for use. A cuff may be included in the mouth part and the slot-and-groove arrangement may be between the cuff and mouth part before the cuff attaches to the exit channel. Or the slot-and-groove arrangement may include between the cuff and exit channel, and or mouth part and cuff. Preferably, screw threads used to install the mouth part are configured to indicate to the user the correct installation. Preferably, the cuff is attached to the exit channel such that appropriate tightening of the screw similarly tightens the cuff to the exit channel with the mouth part in the correct orientation for use. Preferably, one or more visual indicator may be included on the mouth part to show that the orientation with the exit channel is correct. The visual indicator may be a triangle or arrow on the mouth part to be aligned with a triangle or arrow on the exit channel. The visual indicators may be between a cuff of the mouth part and the exit channel.

Preferably, the mouth part has been shaped and sized to suit adult patients unable to feed themselves. Preferably, the mouth part includes a bulb. Preferably, the bulb is made of a suitable soft plastics material. The bulb may be made of silicone. The bulb may be made of a material with a shore hardness rating of substantially 47. Preferably, the wall of the bulb is 1.8 millimetres thick. Preferably, the bulb is configured to be of a suitable softness to be used to be sucked by an adult patient without undue fatigue. Preferably, the recoil of the material is suitable to refill the bulb after emptying. Other suitable hardness of material may be used for the bulb instead. Preferably, the bulb is adapted to fit readily and comfortably in the mouth of an adult. Preferably, the bulb is adapted to fit in the potential space between the central tongue and hard palate of an average adult mouth.

Preferably, the bulb is adapted to be taken into the mouth of the adult patient and compressed by the tongue against the hard palate to increase bulb pressure leading to thickened liquid food being deposited at the back of the mouth.

Preferably, the bulb is shaped so as to wedge and fit the anterior aspect of the tongue. Preferably, the shaped part of the bulb is close to the attachment point to the exit channel.

Preferably, the mouth part includes a hole of a suitable size to enable feeding in a controlled manner. Preferably, the hole is in a bulb of the mouth part and is varied depending on the thickness of liquid food to be fed. The hole may have any suitable diameter for use to feed thickened liquids. The hole may be different sizes on different mouth parts for different purposes. For example, a hole of 0.5 millimetres may be used for Level 150 mildly thick liquids, a hole of 1 millimetre for Level 400, moderately thick liquids and a hole of 2 millimetres may be used for Level 900, extremely thick liquids. Preferably, the hole has a diameter chosen from the group 0.5; 1; and 2 millimetres. Preferably, the hole has a diameter of less than 2 millimetres.

Preferably, a valve arrangement is configured in the bulb to prevent leaks of fluid. Preferably, the valve arrangement assist to enable a suitable tidal volume of fluid to be deposited when the bulb is squeezed. Preferably, one or more prolapsing cusps are included in the bulb associated with the hole. Preferably, there are 4 prolapsing cusps about the hole. Preferably, the hole is surrounded by the 4 prolapsing cusps at the low pressure end of the bulb which lose integrity to assist to deposit the food at the back of the mouth during use. Preferably, the cusps substantially prevent loss of fluid until the bulb is squeezed. Preferably, the mouth part is adapted to resist loss of fluid until squeezed but on squeezing to enable rapid exit. The hole may deform during squeezing to allow more fluid out than when the squeezing is not occurring. Preferably, the bulb is adapted such that recoil refills the bulb ready for the next squeeze.

Preferably, the mouth part extends in generally the same angle as the exit channel. Preferably, the mouth part extends in the range of substantially 25-45 degrees to the vertical. Most preferably, the mouth part extends at substantially 30 degrees to the vertical. Preferably, the mouth part of the cup enables the patient to use the seek, suck and swallow reflex to safely feed at any angle of tilt of the cup.

Preferably, the exit channel and mouth piece together form an angled spout for beneficial controlled delivery of thickened liquid food for an adult patient.

Preferably, use of the mouth part of the cup enables the patient to use the seek, suck and swallow reflex to safely feed. In this way the risk of aspiration or choking is minimised.

Preferably, the flow of the thickened liquid food from the cup is well controlled by the apparatus. Preferably, the control prevents flow of fluid from the mouth part, unless the bulb is squeezed to cause flow. Preferably, the flow is controlled that when the bulb is no longer squeezed the flow of fluid from the mouth part ceases. Preferably, the flow of fluid is only possibly through squeezing the bulb in proper use. In this way drips may be prevented. Most preferably, the controlled flow enables a carer to substantially prevent choking through a build up of unswallowed food. The person will swallow on the use of the reflex, squeezing the bulb and depositing of the food and more food will not flow until the next suck.

Preferably, the mouth part is adapted to provide a useful tidal volume of liquid. Preferably, the tidal volume is at least 3 millilitres. Preferably, a tidal volume of 3 millilitres is consistently fed to the patient due to the sucking leading to recoil to refill the bulb with a further 3 millilitres before feeding of the further 3 millilitres on the next suck to the patient. The controlled tidal volume may form part of the control of the flow defined by the invention. Any suitable tidal volume of liquid may be provided. The tidal volume may be in the range of 2 to 4 millilitres.

Preferably, the mouth part is configured to precisely deposit the liquid food at the central posterior region of the tongue. Preferably, the mouth part is adapted to elicit the suck and swallow reflex and put the liquid food in the correct position for safe swallowing after sucking.

Preferably, the multi-angle cup enables feeding to occur with the cup at any angle. Preferably, the multi-angle cup enables the patient to be at any suitable angle or position and feeding may still safely take place. The patient may be fed using the multi-angle cup in any position chosen from the group: lying down; lying on their side; lying or siting at 45 degrees; or sitting up straight.

Preferably, the tilt of the cup is any suitable angle that the carer or patient can hold the cup. The tilt may be horizontal, vertical or at 45 degrees. The cup may be tilted through a range of suitable angles during a feed.

Preferably, the mouth part includes flow control. Preferably, flow control is such as to prevent loss of fluid when the mouth part is not squeezed. Preferably, the wide opening of the exit channel enables ready filling of the mouth part ready for feeding. In inverted positions gravity may assist to control flow of the fluid. Preferably, the wide opening to the exit channel, and to the bulb, assists flow control, whereas the valve arrangement about the end of the bulb prevents loss of fluid except when squeezed, where fluid is rapidly deposited.

Accordingly, the present invention provides, in a variant, a multi-angle feeding cup for feeding liquid food to a patient, the cup including:
a cup body for containing the liquid food, and including a wall;
an exit channel extending at an angle from the wall; and
a mouth part, extending from the angled exit channel to enable the patient to be
fed liquid food in a controlled manner to the posterior aspect of the tongue,
   wherein the multi-angle feeding cup enables feeding at most angles of tilt of the cup, and the flow of the liquid food is controlled by the mouth piece.

Accordingly, the invention also provides, in a further variant, a multi-angle feeding cup for feeding liquid food to a patient with dysphagia, the multi-angle cup including:
a cup body for containing the liquid food, and including a base and a wall;
an exit channel extending at an angle of 30 degrees from the wall, towards the base; and a shaped mouth part, including a hole with a valve arrangement, the shaped mouth part extending from the angled exit channel to enable the patient to be fed liquid food in a controlled manner to the posterior aspect of the tongue,
   wherein the multi-angle feeding cup enables feeding at substantially any angle of tilt of the cup, and the flow of the liquid food is controlled by the mouth piece such that flow is only possible on squeezing of the mouth part and on doing so the valve facilitates flow of the liquid.

Accordingly, the invention also provides a method of use of a multi-angle cup for feeding a patient, the multi-angle cup including a cup body, including a wall, an exit channel extending from the wall at an angle, and a mouth part for feeding the patient in a controlled manner, the method including the following steps:
a) Place thickened liquid food in the cup body and seal with a lid;
b) Select a mouth part suitable to the thickness of the thickened liquid food;
c) Secure the mouth part to the exit channel of the cup;
d) Tip the exit channel so that fluid fills the mouth part;
e) Test the mouth part by squeezing some fluid out; and
f) Feeding the patient at a suitable angle.

Accordingly, the invention also provides a second method of use of a multi-angle cup for feeding a patient, the multi-angle cup including a cup body, including a wall, an exit channel extending from the wall at an angle, and a mouth part for feeding the patient in a controlled manner, the method including the following steps:
Step 1: Professional prescription of use of suitable mouth part size and premix of thickened liquid food, at the thickness level desired;
Step 2: Selection of the appropriate mouth part and premix thickened liquid food;
Step 3: Mix and shake a suitable volume of premix thickened liquid food in a shaker with a suitable volume of liquid until smooth and well mixed;
Step 4: Pour mixed thickened liquid food mixture into body of cup;
Step 5: Seal with lid;
Step 6: Fit selected mouth part;
Step 7: Tip cup so the mouth part is pointing vertically down so that the liquid food enters the exit channel;
Step 8: Observe to ensure that no liquid exits the mouth part;
Step 9: Squeeze mouth part by pulling between two fingers in a downward motion to expel the tidal volume contents, while the tip of the mouth part is still pointing downwards;
Step 10: Observe to ensure that no further liquid exits the mouth part;

Step 1 may include colour coding of mouth part and premix of a prescribed level of thickness. Preferably, the method is used to test safe feeding of a patient with compromised swallowing ability may occur. Preferably, the testing method includes testing for the ideal viscosities of thickened fluids directly before administration. Preferably, the multi-angle cup offers three adaptations in order to supply independent testing environments for the three different standards of viscosity: Level 150; Level 400; and Level 900. The tidal volume to be delivered may also be tested before feeding a patient. Preferably, only the tidal volume is able to exit with each squeeze. Preferably, only 3 millilitres is able to exit per squeeze.

The order of the steps of the method may be varied somewhat within the scope of the invention. It is most beneficial to include the test and observe steps but these could be omitted without moving beyond the scope of the claimed method. Preferably, testing of the apparatus and tidal volume occurs before feeding of the patient.

The multi-angle cup of the method may be the multi-angle cup of the invention, in any of its forms or variants.

### BRIEF DESCRIPTION OF THE DRAWINGS

The invention will now be described in connection with a non-limiting preferred embodiment of the invention, with reference to the accompanying drawings, in which:

FIG. 1 is a side view of the prior art cup of the inventor, for illustrative purposes only;

FIG. 2 is a perspective view from above of a multi-angle feeding cup, according to a preferred embodiment of the invention;

FIG. 3 is a side view of the multi-angle feeding cup of FIG. 2, held in the hand of a person, and in an inverted position;

FIG. 4 is a side view of the multi-angle feeding cup of FIGS. 2 and 3, in an upright position, such as placed on a surface;

FIG. 5 is a detailed view of the mouth piece of the multi-angle feeding cup of FIGS. 1 to 4;

FIG. 6 is a side view of the multi-angle feeding cup of FIGS. 2 to 4, illustrating feeding at 90 degrees to the vertical;

FIG. 7 is a perspective view from behind of the multi-angle feeding cup of FIGS. 2 to 4, and 6:

FIG. 8 is a plan view from below, of the multi-angle feeding cup of FIGS. 2 to 4, 6, and 7;

FIG. 9 is a detailed view of the lower part of the multi-angle feeding cup of FIG. 7 illustrating the handles and grip portions in particular;

FIG. 10 is a detailed view of a handle and grip of the cup of FIG. 7;

FIG. 11 is horizontal transection of the mouth piece of the cup of FIGS. 2 to 10, illustrating the end plate and cusps:

FIG. 12 is the vertical transection of the mouth piece of the cup of FIGS. 2 to 10, illustrating the end plate and cusps; and

FIG. 13 is an end on view of the end plate of FIGS. 11 and 12 surrounding the hole of the mouth piece.

### DETAILED DESCRIPTION OF THE INVENTION INCLUDING A BEST MODE

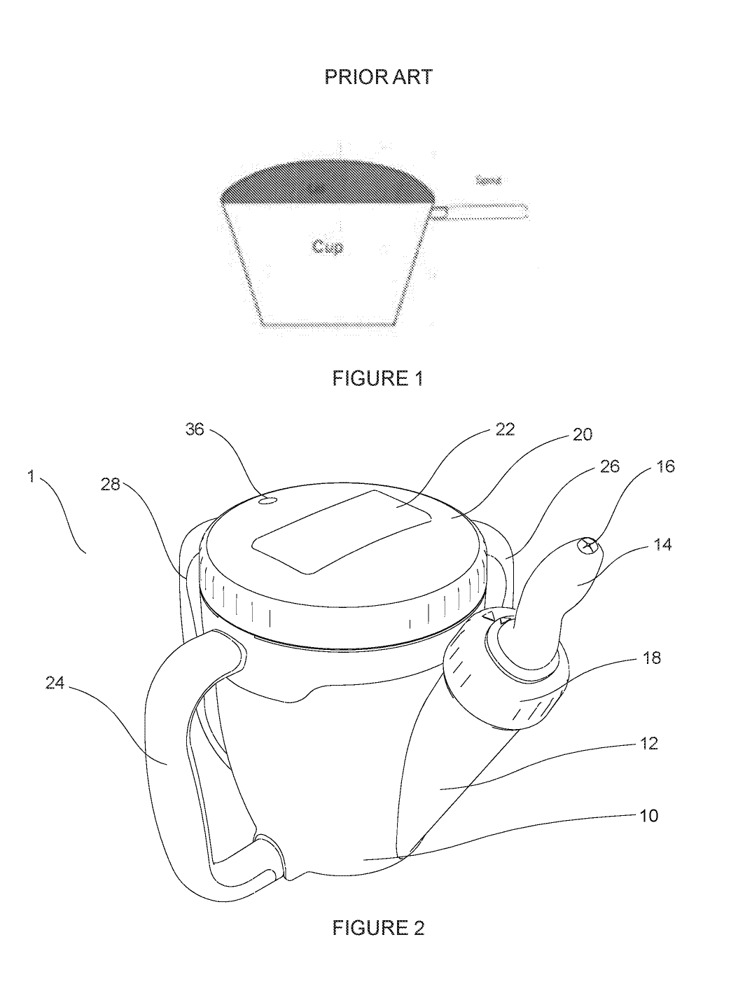

Referring to FIG. 1 the prior art cup of the inventor is illustrated, showing a long wide spout extending at a right angle to the wall. Use of the seek, suck and swallow autonomic reflexes is used to feed adults by utilising the long spout with a wide aperture. Once the reflex is initiated the patient will suck on the spout to take the food. The prior art invention has been used successfully and the subject patent application is for significant new developments to the original concept developed over the last 5 years

Referring to FIGS. 2 to 13, a preferred embodiment of the invention will be described, where multi-angle feeding cup 1, has body 10 and exit channel 12. Exit channel 12 has flexible mouth piece 14 attached with hole 16 to feed thickened liquid food to a patient; the patient, and thickened liquid food is omitted throughout, for ease of illustration. The thickened liquid food products are proprietary products of the inventor, sold under the brand NutriTaste (Trade Mark). Use of the proprietary NutriTaste (Trade Mark) is of particular benefit with the invention, and have been developed to work together. However, the invention may be used with any thickened liquid food product.

Exit channel 12 is joined at cuff 18 to mouth piece 14 to enable ready removal and interchange of mouth piece 14. Mouth piece 14 is attached with a slot-and-groove arrangement with a triangular Cuff 18 enables these mouth pieces 14 to be quickly and easily screwed onto exit channel 12. The screwing is adapted so that when screwed tight mouth piece 14 will be in the correct orientation. Various forms of mouth piece 14 are supplied, for different fluid thicknesses and these different, colour coded mouth pieces 14 can be readily installed ready for feeding an appropriate thickness of liquid. Cuff 18 is supplied with cup 1, and mouth piece 14 is replaced, as required. However, these parts could be supplied together or in an integral form, possibly in a disposable form of the invention.

Lid 20 with label 22, and handles 24, 26, 28 complete cup 1 to create a fully multi-angle feeding cup that may be inverted and liquid food does not fall out, but can be fed through hole 16 in a safe and controlled manner. Body 10, exit channel 12, cuff 18 and lid 20 of multi-angle feeding cup 1 are all illustrated made of a rigid plastics material, namely Acrylonitrile butadiene styrene (“ABS”) to be strong and resistant to damage. Other materials could be used instead, if desired. Plastic is useful as it is light, easy to clean and can be made in many colours to assist to distinguish one cup from another when used.

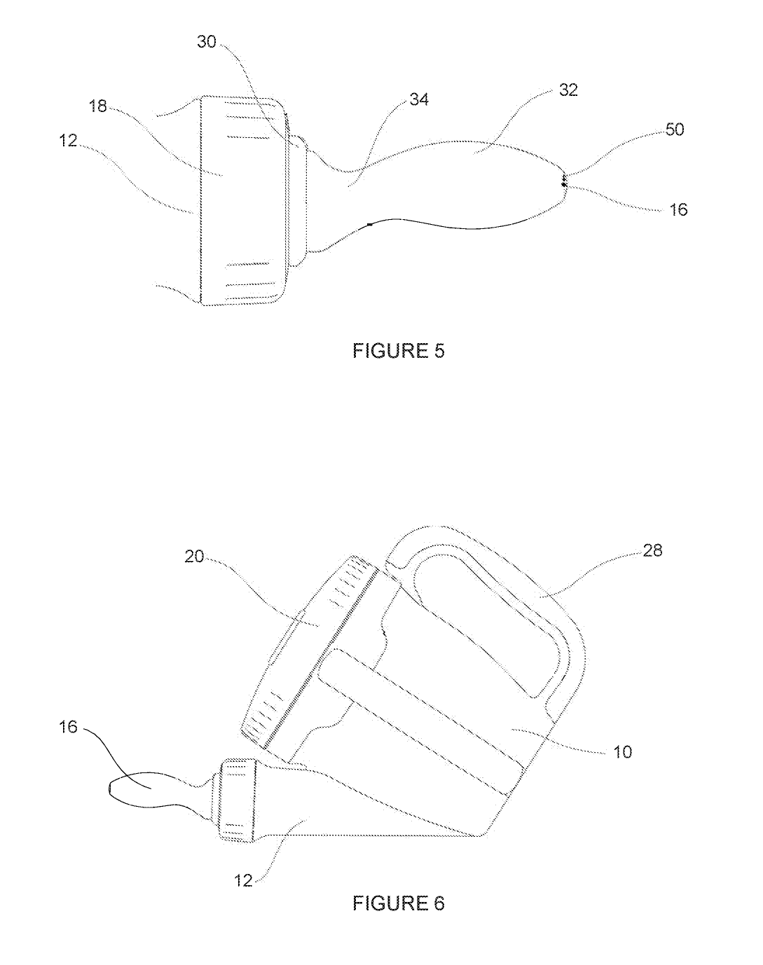

Mouth piece 14 is made of a soft silicone, rating 47 on the Shore hardness scale, as has been found particularly suitable. The particular shore values might be adjusted to allow for variation in strengths of muscles inside and surrounding the buccal cavity (i.e. more or less resistance from the silicone exit channel), in variant forms of the invention. Mouth piece 14 has been ergonomically designed with maximum feeding function in mind, to be taken into the mouth of an adult patient without discomfort. Mouth piece 14 has been designed to be a significant improvement over the prior art for feeding thickened liquid food to an adult using the seek, suck and swallow reflex. Referring to FIG. 5 in particular, mouth piece 14 can be seen to join at 30 to cuff 18. Cuff 18 enables strong attachment of mouth piece 14 to exit channel 12, by a screw fit. The specific ergonomic design of mouth piece 14 demands an exact spatial orientation to the device. This exact orientation ensures that the palate and tongue applications of especially shaped mouth piece 14 are not confused. To ensure the accurate assembly of mouth piece 14 on exit channel 12, two design modifications are included:
1. A slot-and-groove matching design between mouth piece 14 and the cuff 18 ensures that mouth piece 14 is correctly orientated to the cuff 18; and
2. Careful tweaking of the screw thread of cuff 18 ensures that after tightening of cuff 18 onto mouth piece 14 it will be also be correctly orientated to the device. A small triangle on cuff 18 faces a second triangle on the hard exit channel 12 confirming the correct instalment.

The screw fit is useful as it is readily understood and used by a carer, and once installed can resist strong pressures. For example, the significant pressures created during use, such as gravitational force when inverted, or the sucking force in use. It is important that use of multi-angle feeding cup 1 is convenient for the user, and the screw on interchange of mouth piece 14 is part of the many clever design features.

Mouth piece 14 also includes bulb 32, another important feature. Bulb 32 has taken careful experimentation to find the suitable thickness of material for bulb 32, as well as the correct size and shape to fit the potential space between the central tongue and hard palate of an average adult mouth. In an elderly patient the tongue may fatigue easily if bulb 32 and other parts of mouth piece 12 are made of a material too strongly resistant. If the material bulb 32 is too soft then there is insufficient propulsion. A firm and effective recoil of bulb 32 is desirable, so that bulb 32 refills with thickened liquid after suction and deposit of the material has occurred. After extensive experimentation, bulb 32 is found to have optimal function where the wall is 1.8 millimetres thick silicone with a shore hardness value of 47. All of mouth piece 14 is made of silicone of this form, and varies only in shape and thickness of wall, for example, the walls at the hole being arranged to create a valve, as described below.

Once bulb 32 of mouth piece 14 is in the mouth of the patient it is compressed by the tongue against the hard palate to increase bulb pressure, which is beneficial during feeding. Shaped part 34 of mouth piece 14 is designed to fit and wedge the anterior aspect of the tongue, in use, to assist to feed the patient in a safe, comfortable and efficient manner. Hole 16 at the low pressure end of bulb 32, loses integrity due to thinner walled prolapsing cusps, to facilitate the controlled deposit of the thickened liquid food to the back of the tongue of the patient.

As illustrated mouth piece 14 is coloured green, indicating that hole 16 has a diameter of 0.5 millimetres and is suitable for mildly thick liquids, Level 150. Alternative mouth pieces 14 are also supplied, colour coded to make it quick and easy to find an appropriate mouth piece 14 to use with the particular thickness of liquid. Where mouth piece 14 is purple silicone, this indicates that hole 16 has a diameter of 1 millimetres and is suitable for moderately thick liquids, Level 400. Similarly, where mouth piece 14 is blue, this indicates that hole 16 has a diameter of 2 millimetres and is suitable for extremely thick liquids, Level 900. Clearly, these colours can be varied, and different manners of indicating the type of mouth piece 14 used instead. These colours have been adopted by Australian Standards as standardised with the levels of thickness to facilitate the correct use by carers.

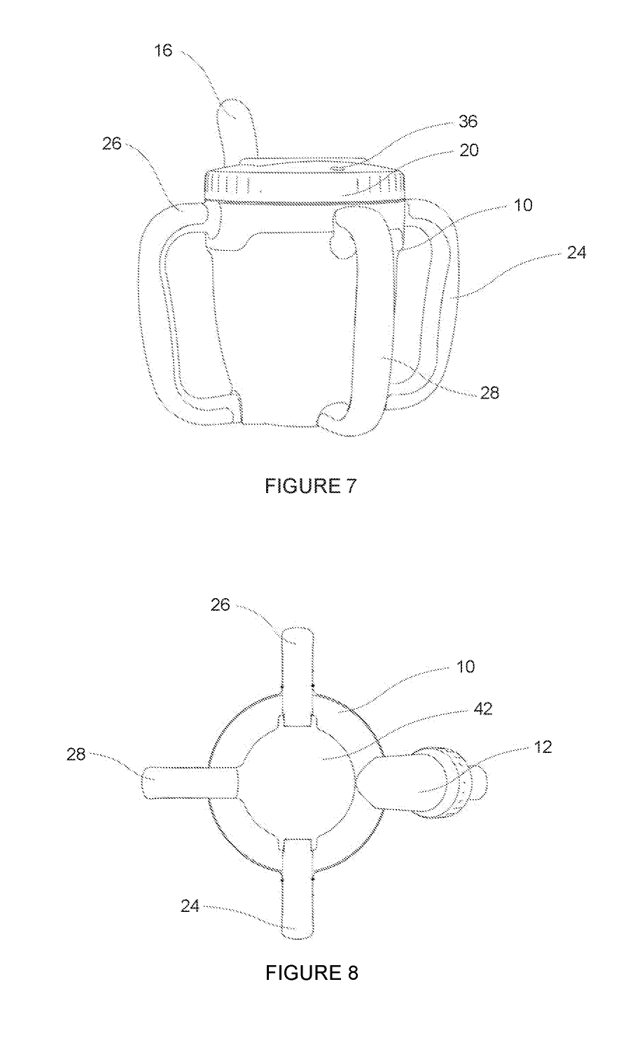

Handles 24, 26, and 28 run from base 42, towards lid 20, to allow comfortable and easy holding, as shown in particular in FIGS. 7 to 10. Base 42 is a flat, stable base ensuring maximum stabilisation of cup 1 when placed on a surface to minimise accidental tipping over.

Use of multiple handles 24, 26 and 28 gives more options to hold cup 1, in every direction, which is a significant advantage. For example, where a person may be leaning over to reach the mouth of a person it may be more convenient to use a side handle, this may change if used by a person who is left rather than right-handed. In other positions it may be more convenient to use the rear handle.

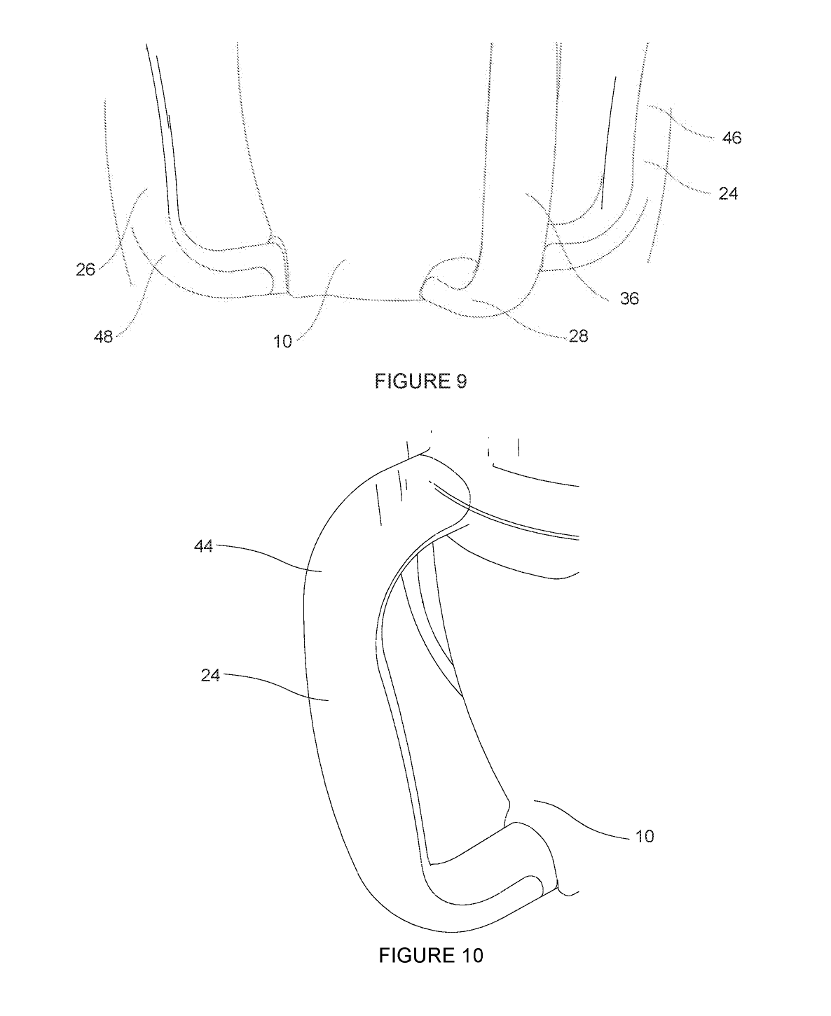

Referring to FIGS. 9 and 10 in particular, handles 24, 26 and 28 include a soft grip portion 44, 46 and 48, respectively. As shown the grip is coloured to add to the aesthetic appeal of the design. Grip portions 44, 46 and 48 as illustrated are formed of a silicone over mould to rigid plastics handles 24, 26 or 28 below. Grips 44, 46 and 48 improve grip and hold of cup 1 in either hand and in any direction. The grip of an elderly person, or person who is neurologically compromised is often weak or uncoordinated. Therefore use of a soft grip assists the patient to maintain grip and hold on handles 24, 26 or 28. Textured grips or alternative grips could be used instead, or the grip portions could be omitted in another form of the invention. Use of three handles 24, 26 and 28 is most advantageous allowing the carer to assist to any level. The patient may hold handles 24 and 26, for example, and the carer may keep a light hold on handle 28 in care of loss of grip or to assist with tilting. The carer may hold any one of handles 24, 26 or 28 or more if convenient in order to feed the patient at any angle or position.

Pressure hole 36 is included in lid 20, to relieve pressure that may be created in body 10 of cup 1, in the usual fashion.

A speech therapist, dietician or other health care professional may prescribe use of a particular level of thickness of food and so the associated mouth piece 14. Introduction of standardised systems and formulas in this regard assist to follow through on these prescriptions for the best feeding outcome for the patient.

Premix formulas provided by the inventor's company or others are intended to be adjusted to comply with the three levels of thickness and the three mouth piece 14 configurations. A colour co-ordinated approach to the packaging for the premix makes the system simpler again, and for the instructions for the particular thickness. For example, 50 grams of a premix formula of Level 2 mixed with 250 millilitres of water should exactly suit the standardised thickness level of Level 2, Level 400 moderately thick. In this way, the premixed liquid food Level 400, should comply perfectly with use of the inventive multi-angle cup 1, with purple mouth piece 14, having hole 16 with a 1 millimetre diameter. In another example, 50 grams of a premix formula of Level 1 mixed with 250 millilitres of water should exactly suit the standardised thickness level of Level 1, Level 150 mildly thick and so would be used with green mouth piece 14 having hole 16 with 0.5 millimetre diameter. Likewise blue mouth piece 14 would be used where the premix formula is made up according to the instructions to level 3, Level 900 extremely thick. Clearly, the instructions, proportions and colours can be varied. However, as the process is standardised, including the thicknesses and colours, it will be much easier and quicker for the liquid food to be made and fed correctly and safely.

Use of a standardised safety protocol (the “Safety Protocol”) directly before feeding the patient is most preferred and will proceed as follows:
Step 1: Professional prescription of use of suitable mouth piece size and premix at the thickness level desired;
Step 2: Selection of the appropriate mouth piece 14 and premix; these are colour coded and coordinated for quick and easy selection;
Step 3: Mix and shake 50 grams of premix in a shaker with 250 millimetres of water for 30 seconds until smooth and well mixed;
Step 4: Pour mixed thickened liquid food mixture into body 10 of cup 1;
Step 5: Seal by screwing on lid;
Step 6: Fit appropriate size of mouth piece 14 by screwing on cuff 18;
Step 7: Tip cup 1 so mouth piece 14 is pointing vertically down over a receptacle for a few seconds so that the liquid food enters exit channel 12;
Step 8: Observe for 10 seconds to ensure that no liquid exits hole 16;
Step 9: Milk mouth piece 14 by pulling between two fingers in a downward motion to expel the content of mouth piece 14 onto the plate while in the downward orientation; and
Step 10: Observe for a further 10 seconds to ensure that no further liquid exits hole 16.
As described fluid flow is strictly controlled so that only on the milking of mouth piece 14 will fluid flow and no dribbling or dripping should occur once the milking action has ceased. The milking action, in use, is caused by use of the seek, suck and swallow reflex elicited in the patient. It is most beneficial that the flow is so precisely controlled, so that it can be stopped immediately, if need be, without additional flow.

Trouble shooting advice may be provided such as if the fluid is too thick it will not run out of mouth piece 14, even on milking, if the fluid to thin it may dribble out of hole 16 on tipping. In these cases cup 1 must be cleaned and a fresh premix made to the correct consistency used instead.

The prior art invention of the inventor, when used with very thick liquids required a strong tension to be created with the suck reflex to get the thick liquid out of the spout in a sufficient volume to feed an adult. The tip was used to stimulate the posterior region of the tongue so the patient sucked on and swallowed using the autonomic reflex. The method works well but does have some limitations.

The typical adult tidal volume of liquid, eg volume per suck, is typically 4 to 8 millilitres; the maximum tidal volume of bulb 32 of the invention has been set to a conservative 3 millilitres. Use of a spout hole of 2 millimetres wide enables 3 millilitres to be sucked, which is satisfactory. However with a 1 millimetre spout hole, a tidal volume of only 0.5 to 1 millilitre is achieved and with a 0.5 millimetre spout hole this may be reduced further to 0.25 to 0.5 millilitres, clearly these last two volumes are dissatisfactory volumes per suck for feeding an adult. Use of these smaller spout holes is desirable for Levels of thickness below 900 so that flow can be controlled and does not simply run out of the hole.

To address the serious issue of lack of tidal volume, as described above, careful development and experimentation was undertaken to develop a mouth piece that would produce the desired tidal volumes for use with the different levels of thickness of fluid.

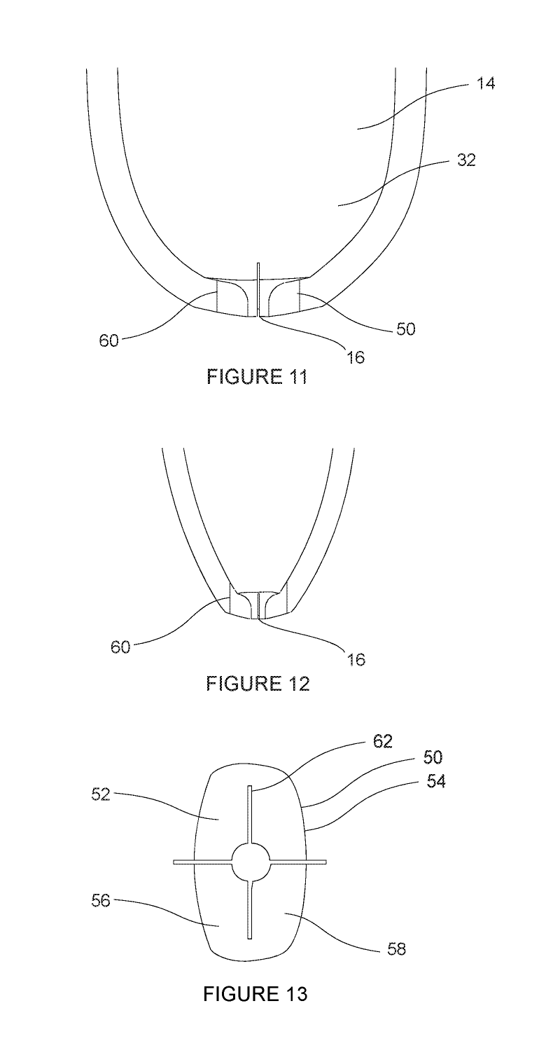

Referring in particular to FIGS. 11 to 13, the detail of the new and inventive mouth piece 14 is illustrated. Endplate 50 surrounds hole 16 and has 4 cusps 52, 54, 56 and 58, each anchored at anchor points 60. The anchoring at anchoring points 60 is through the change in wall thickness as can be seen using a 90 degree angle. Endplate 50 is 0.8 millimetres thinner than the surrounding wall of 1.8 millimetres thick and slightly concave in shape. Use of the 90 degree anchoring maintains a good firm but safe recoil, maintaining the integrity of the tip of bulb 32, to prevent leakage. As bulb 32 of mouth piece 14 is milked the concave shape is extenuated, assisting to open hole 16 so fluid may exit; this may be in testing or due to sucking action of the patient during use.

Cusps 52, 54, 56 and 58 have a cross-shaped cut 62 introduced for the 0.5 millimetres and 1 millimetres holes 16 to assist flow during use. Cut 62 as illustrated is 3 millimetres along the vertical axis and 5 millimetres along the horizontal axis. Use of cut 62 creates the valve properties of slightly curved cusps 52, 54, 56 and 58 which prolapse on squeezing of bulb 32 to assist fluid to exit bulb 32. Use of cusps 52, 54, 56 and 58 enable delivery of 3 millilitres, a safe and efficient feeding tidal volume, of thickened liquid, exactly where needed at the correct position on the tongue, a significant improvement on the prior art. Without use of the valve arrangement, fluid may drip or dribble out in an uncontrolled manner which is undesirable. Use of the particular bulb and valve of the invention enables controlled flow, only on squeezing does an appropriate tidal volume of thickened liquid food exit to the back of the tongue of the patient.

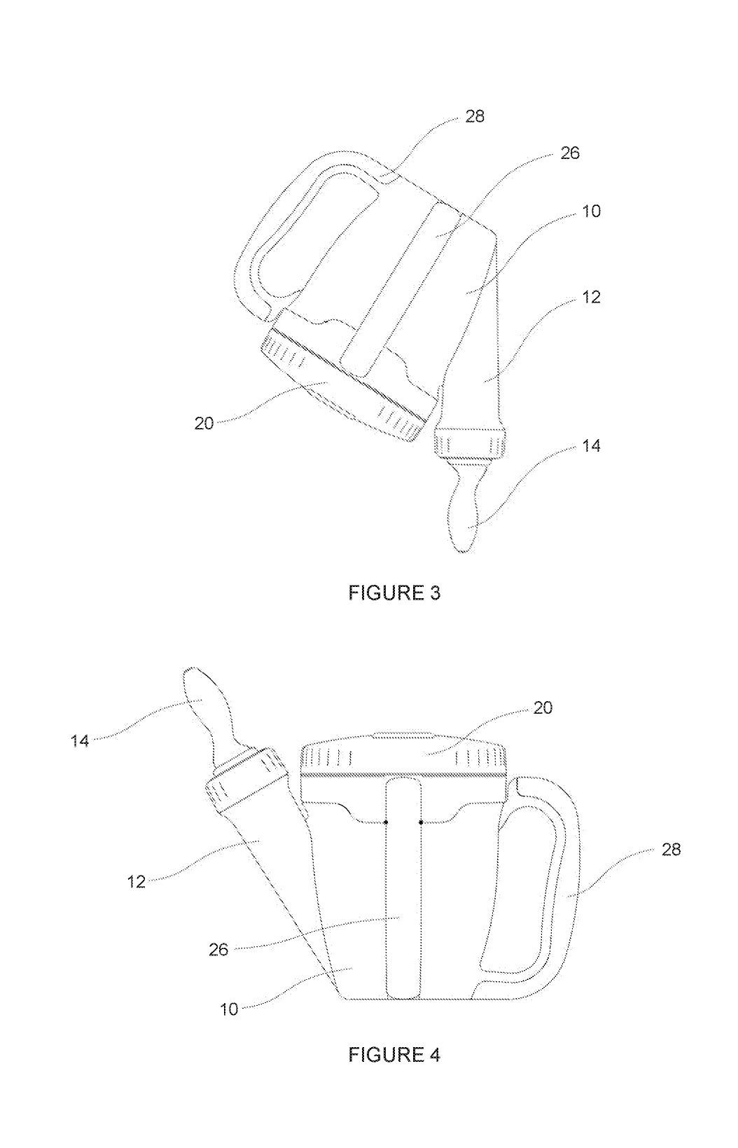

Use of endplate 50, with cusps 52, 54, 56, and 58 enables feeding of a patient with cup 1 in the fully inverted position (refer FIG. 3) and the patient lying down. Use of cup 1 therefore provides significantly more safe and effective feeding choices to the carer, even when the patient is not sitting upright.

Overall the design of mouth piece 14 has been carefully made, to suit the particular requirements to feed and adult and fit appropriately into an adult mouth. The superior surface is designed to follow the contours of an adult palate, and the inferior surface to place optimal safe volume of 3 millilitres per tidal volume as per bulb 32 on the mid-section of the tongue of the patient. Shaped part 14 wedges the anterior aspect of the tongue beneficially at the base of the bulb 32 to obstruct the inlet. With pressure by the central-anterior section of the tongue against bulb 32 a high pressure environment is created leading to flow of content towards hole 16 encouraging exit of the fluid to the back of the tongue. The thickened liquid food needs to be deposited at the central back of the tongue as part of the suck and swallow reflex, which minimises choke risk and improves the ability of the patient to take the food.

Before thickened fluid reaches mouth piece 14 it must pass from body 10 into exit channel 12. To facilitate this fluid enters exit channel 12 at base 42 level, different to the prior art. The position of the internal entrance to exit channel 12 has been carefully developed so that maximum fluid enters exit channel 12 through an internal opening, wide enough to enable even Level 900, extremely thick fluid, to readily enter. Previously, fluid of this thickness must be spoon fed to a patient as it was too thick to suck up or flow through use of a lidded cup, for example. Exit channel 12 is designed at an angle of 30 degrees from the vertical with a large opening, 22 millimetres by 55 millimetres which does enable the ready passage of these thick and extremely thick fluids. When cup 1 is tilted in positions during feeding, gravity assists flow and movement of the thick fluids into exit channel 12 from body 10 towards mouth piece 14. The solid round exit of exit channel 12, with a diameter of 22 millimetres, facilitates the exit flow of thickened fluid in a spontaneous but controlled fashion resulting in a generous but controlled presentation of volume to mouthpiece 14.

Once the thickened fluid has filled exit channel 12 it enters mouth piece 14 through the internal opening, increasing the pressure inside. The pressure in bulb 32 further increases with the upward movement of the tongue towards the hard palate, compressing bulb 32, as described above. Cusps 52, 54, 56 and 58 resist prolapsing until there is sufficient pressure created by the presence of the liquid and the compression of bulb 32. There is high pressure generated by the gravitational force on the thickened liquid and the compression force in bulb 32. However, the valve created by cusp 52, 54, 56 and 58 is a low pressure valve, due to the prolapsing cusps so that should there be a reason for the valve and opening to fail the thickened liquid does not squirt out but continues to be controlled. The controlled flow from a high pressure environment to a low pressure exit to deposit the thickened liquid on the desired position at the posterior aspect of the adult tongue, is advantageous.

Use of multi-angle cup 1 is a significant improvement over the art in a number of ways. Patients with dysphagia traditionally are unable to be fed unless reclined at 45 degrees and spoon fed. Clearly, spoon feeding is laborious work, and is restricted by first positioning the person into the correct inclination. Elderly patients can be very restricted in their neck movements and positioning out of this range can lead to discomfort, vertigo, dizziness or even a loss of consciousness where there is a constriction. Hyperextension of the neck is most undesirable, as is use of the 45 degree angle which has an increased aspiration risk. Patients with dysphagia could not, therefore, be fed traditionally sitting up, or lying down, only at the specific 45 degree angle. Use of multi-angle cup 1 enables these dysphagia and other patients to be safely and efficiently fed when lying down or sitting up, and other angles in between, due to the controlled depositing of the thickened liquid. For example, in FIG. 6 feeding in a sitting up position at 90 degree angle is usefully illustrated.

Where a patient is neurologically compromised such as hemiplegia, hemiparesis, head injuries, cerebral palsy or other neurological conditions the manual dexterity of the patient is likely to be significantly compromised. In which case it is likely that a patient may have difficulty in holding a traditional single handled cup. Even if a cup has two handles this may be still difficult to hold by the patient, necessitating the carer to try to assist. Cup 1 has three handles, 24, 26 and 28 which enable the carer to hold from any angle. The patient can also hold from any angle, in one or two hands and the carer can also hold a third handle while the patient uses the cup. It is yet another advantage of the subject invention that there is the ability to use cup 1 by both carer and patient at the same time, in a safe manner, as well as access from any direction, due to the three handles.

It will be apparent to a person skilled in the art that changes may be made to the embodiment disclosed herein without departing from the spirit and scope of the invention, in its various aspects.

### INDUSTRIAL APPLICABILITY

The multi-angle cup of the invention may be produced industrially and supplied direct to customers, to retailers, wholesalers or to medical professionals directly.

### REFERENCE SIGNS LIST

| | |
|---|---|
| 1 | Feeding Cup |
| 10 | Body of Cup |
| 12 | Exit channel |
| 14 | Mouth piece |
| 16 | Hole in mouth piece |
| 18 | Cuff |
| 20 | Lid |
| 22 | Label for lid |
| 24 | Handle |
| 26 | Handle |
| 28 | Handle |
| 30 | Join of 14 to 12 |
| 32 | Bulb of 14 |
| 34 | Shaped part of 14 |
| 36 | Pressure hole |
| 38 | |
| 40 | |
| 42 | Base |
| 44 | Grip of 24 |
| 46 | Grip of 26 |
| 48 | Grip of 28 |
| 50 | Endplate of 14 |
| 52 | Cusp |
| 54 | Cusp |
| 56 | Cusp |
| 58 | Cusp |
| 60 | Anchoring point |
| 62 | Cut |
| 64 | |
| 66 | |
| 68 | |
| 70 | |
| 72 | |
| 74 | |
| 76 | |
| 78 | |

1-19. (canceled)

20. A multi-angle feeding cup for feeding liquid food to a patient, the cup comprising:
a cup body for containing the liquid food, and including a wall;
an exit channel extending at an angle from the wall; and
a mouth part extending from the angled exit channel at an inclined angle, and the mouth part including a bulb with a hole and a valve arrangement, the hole being of a suitable size to enable feeding with a controlled flow rate, depending on the thickness of liquid food to be fed, and the mouth part and bulb with valve arrangement and hole being adapted to enable the patient to be fed liquid food with a controlled flow rate and controlled tidal volume, to the posterior aspect of the tongue,
wherein the multi-angle feeding cup enables feeding at substantially any angle of tilt of the cup.

21. The multi-angle cup of claim 20, wherein three handles are included, one on either side of the exit channel and one to the rear enabling ready use of the multi-angle cup in any direction with a choice of multiple holds.

22. The multi-angle cup of claim 20, wherein the exit channel is a wide channel with a large opening with the body of the cup of at least 20 millimeters wide.

23. The multi-angle cup of claim 20, wherein the exit of the exit channel to the mouth part is at least 20 millimeters wide.

24. The multi-angle cup of claim 20, wherein the exit channel extends at an angle of substantially 30 degrees to the vertical.

25. The multi-angle cup of claim 20, wherein the bulb is adapted to fit in the potential space between the central tongue and hard palate of an average adult mouth and adapted to be taken into the mouth of the adult patient and compressed by the tongue against the hard palate to increase bulb pressure leading to thickened liquid food being deposited at the back of the mouth.

26. The multi-angle cup of claim 20, wherein the bulb is shaped so as to wedge and fit the anterior aspect of the tongue.

27. The multi-angle cup of claim 26, wherein, the hole has a diameter of less than 2 millimeters.

28. The multi-angle cup of claim 26, wherein a mouth part with a hole of 0.5 millimeters is used for Level 150, mildly thick liquids, a mouth part with a hole of 1 millimeter for Level 400, moderately thick liquids, and a mouth part with a hole of 2 millimeters is used for Level 900, extremely thick liquids.

29. The multi-angle cup of claim 20, wherein the valve arrangement is configured in the bulb to prevent leaks of fluid and assist to enable a suitable tidal volume of fluid to be deposited when the bulb is squeezed.

30. The multi-angle cup of claim 20, wherein one or more prolapsing cusps are included in the bulb, associated with a hole at the low pressure end of the bulb which lose integrity to assist to deposit the food at the back of the mouth during use.

31. The multi-angle cup of claim 20, wherein the mouth part extends at generally 30 degrees to the vertical.

32. The multi-angle cup of claim 20, wherein use of the mouth part of the cup enables the patient to use the seek, suck and swallow reflex to safely feed at any angle of tilt of the cup.

33. The multi-angle cup of claim 20, wherein the mouth part is adapted to provide a useful tidal volume of liquid of least 3 milliliters.

34. The multi-angle cup of claim 20, wherein the mouth part is configured to precisely deposit the liquid food at the central posterior region of the tongue.

35. The multi-angle cup of claim 20, wherein the patient may be fed using the multi-angle cup in any position chosen from the group: lying down; lying on their side;
lying or siting at 45 degrees; or sitting up straight.

36. A method of use of a multi-angle cup for feeding a patient, the multi-angle cup including a cup body, including a wall, an exit channel extending from the wall at an angle, extending at an inclined angle, and a mouth part including a bulb having a valve arrangement and a hole of a suitable size to enable feeding with a controlled flow rate, depending on the thickness of liquid food to be fed, the mouth part and bulb with valve and hole being adapted for feeding the patient in with a controlled flow rate and controlled tidal volume, the method comprising the following steps:
a) Place thickened liquid food in the cup body and seal with a lid;
b) Select a mouth part suitable to the thickness of the thickened liquid food;
c) Secure the mouth part to the exit channel of the cup;
d) Tip the exit channel so that fluid fills the mouth part;
e) Test the mouth part by squeezing some fluid out; and
f) Feeding the patient at a suitable angle.

37. A method of use of a multi-angle cup for feeding a patient, the multi-angle cup including a cup body, including a wall, an exit channel extending from the wall at an angle, extending at an inclined angle, and a mouth part including a bulb having a valve arrangement and a hole of a suitable size to enable feeding with a controlled flow rate, depending on the thickness of liquid food to be fed, the mouth part and bulb with valve and hole being adapted and a mouth part for feeding the patient with a controlled flow rate and controlled tidal volume the method comprising the following steps:
Step 1: Professional prescription of use of suitable mouth part size and premix of thickened liquid food, at the thickness level desired;
Step 2: Selection of the appropriate mouth part and premix thickened liquid food;
Step 3: Mix and shake a suitable volume of premix thickened liquid food in a shaker with a suitable volume of liquid until smooth and well mixed;
Step 4: Pour mixed thickened liquid food mixture into body of cup;
Step 5: Seal with lid;
Step 6: Fit selected mouth part;
Step 7: Tip cup so the mouth part is pointing vertically down so that the liquid food enters the exit channel;
Step 8: Observe to ensure that no liquid exits the mouth part;
Step 9: Squeeze mouth part by pulling between two fingers in a downward motion to expel the tidal volume contents, while the tip of the mouth part is still pointing downwards;
Step 10: Observe to ensure that no further liquid exits the mouth part.
